(19) United States
(12) Patent Application Publication
(10) Pub. No.: US 2008/0259249 A1
(43) Pub. Date: Oct. 23, 2008

(54) DISPLAY APPARATUS

(75) Inventor: Se-In Chang, Gyeonggi-do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/104,148

(22) Filed: Apr. 16, 2008

(30) Foreign Application Priority Data
Apr. 17, 2007 (KR) 10-2007-0037571

(51) Int. Cl. G02F 1/1335

(52) U.S. Cl. 349/65

(57) ABSTRACT

A display apparatus includes at least one display substrate, a light source which generates light, and a light-guide substrate which guides light generated by the light source to emit light toward the at least one display substrate. The light-guide substrate includes an incident surface adjacent to the light source, a first surface and a second surface. The first surface is extended from the incident surface and includes a first color filter layer which is formed thereon and displays color, and the second surface is opposite to the first surface.

This application claims priority to Korean Patent Application No. 2007-37571 filed on Apr. 17, 2007, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus. More particularly, the present invention relates to a display substrate for a display apparatus.

2. Description of the Related Art

Generally, mobile electronic devices such as mobile communication units, digital cameras, electronic schedulers, etc. include display apparatuses. There are various types of display apparatuses. However, small and light display apparatuses are largely employed in the mobile electronic devices: based on the properties of the mobile electronic devices. For example, liquid crystal display (“LCD”) apparatuses are largely employed in the mobile electronic devices.

Recently, many products have employed bidirectional display apparatuses which display two images that are identical or different from each other in two directions different from each other.

The bidirectional display apparatuses are classified into a twin-type and a two-way type. The twin-type display apparatus includes two light units and two display panels which display images in two directions. The two-way type display apparatus includes one light unit and two display panels which display images in two directions.

The twin-type or two-way type display apparatus include a large thickness since the twin-type or two-way type display apparatus includes one or two light units and two display panels.

### BRIEF SUMMARY OF THE INVENTION

The present invention has been made in an effort to solve the above stated problem, and aspects of the present invention provide a display apparatus capable of reducing manufacturing costs and a thickness thereof.

In an exemplary embodiment, the present invention provides a display apparatus which includes at least one display substrate which displays an image, a light source which generates light, and a light-guide substrate which guides the light generated by the light source to emit the light toward the at least one display substrate. The light-guide substrate includes an incident surface, a first surface and a second surface, the incident surface is adjacent to the light source, the first surface is extended from the incident surface and includes a first color filter layer formed thereon which displays color, and the second surface is opposite to the first surface.

According to an exemplary embodiment, the light-guide substrate further includes a first optical pattern and a second optical pattern. The first optical pattern is formed on the first surface, and disperses and reflects light. The second optical pattern is formed on the second surface, and disperses and reflects light.

According to an exemplary embodiment, the light-guide substrate further includes a second color filter layer which is formed on the second surface and displays color.

According to an exemplary embodiment, the light-guide substrate further includes a first common electrode which is formed on the first surface and transmits light and a second common electrode which is formed on the second surface and transmits light.

According to an exemplary embodiment, the light-guide substrate further includes a first black matrix which is formed on the first surface and blocks light transmitted among filters of the first color filter layer, and a second black matrix which is formed on the second surface and blocks light transmitted among filters of the second color filter layer.

According to an exemplary embodiment, the at least one display substrate includes a first display substrate and a second display substrate. The first display substrate is disposed on the first surface of the light-guide substrate and displays an image, and the second display substrate is disposed on the second surface of the light-guide substrate and displays an image.

According to an exemplary embodiment, the first display substrate includes a first thin-film transistor (“TFT”) layer and a first pixel electrode. The first TFT layer includes at least one TFT formed in each pixel. The first pixel electrode is formed on the first TFT layer.

According to an exemplary embodiment, the second display substrate includes a second TFT layer and a second pixel electrode. The second TFT layer includes at least one TFT formed in each pixel. The second pixel electrode is formed on the second TFT layer.

According to an exemplary embodiment, the display apparatus further includes a first liquid crystal layer and a second liquid crystal layer. The first liquid crystal layer is formed between the first display substrate and the light-guide substrate. The second liquid crystal layer is formed between the second display substrate and the light-guide substrate.

According to another exemplary embodiment, the present invention provides a display apparatus which includes a first display substrate, a second display substrate, a light source which generates light, and a light-guide substrate which guides light generated by the light source to emit light towards the first display substrate and the second display substrate. The light-guide substrate includes an incident surface adjacent to the light source, a first surface extended from the incident surface and a second surface opposite to the first surface. The first display substrate is disposed on the first surface of the light-guide substrate and includes a first TFT layer and a first color filter layer which is formed thereon and displays color. The second display substrate is disposed on the second surface of the light-guide substrate and includes a second TFT layer and a second color filter layer which is formed thereon and displays color.

According to another exemplary embodiment, the present invention provides a display apparatus which includes a first display substrate, a second display substrate, a light source which generates light, and a light-guide substrate which guides light generated by the light source to emit light towards the first display substrate and the second display substrate. The light-guide substrate includes a first optical pattern which disperses and reflects light, a first color filter layer which displays color, a second optical pattern which disperses and reflects light, and a second color filter layer which displays color. The first optical pattern and the first color filter layer are formed oh a first surface of the light-guide substrate. The second optical patterns and the second color filter layer are formed on a second surface of the light-guide substrate opposite to the first surface. The first display substrate is disposed on the first surface. The first display substrate includes a first TFT layer including at least one TFT formed in each pixel. The second display substrate is disposed on the second surface. The second display substrate includes a second TFT layer having, at least one TFT formed in each pixel. The light source is disposed adjacent to a side of the light-guide substrate.

According to an exemplary embodiment, in the display apparatus, a color filter substrate is disposed between two display substrates so that manufacturing costs may be reduced and a thickness of the display apparatus may be decreased.

### BRIEF DESCRIPTION OF THE DRAWINGS

The above and/or other aspects, features and advantages of the present invention will become more apparent from the, following detailed description when taken in conjunction with the accompanying drawings, in which:

FIG. 1 is an exploded perspective view illustrating an exemplary embodiment of a display apparatus according to the present invention;

FIG. 2 is a cross-sectional view illustrating the display apparatus shown in FIG. 1;

FIG. 3 is an enlarged plan view illustrating a region ‘A’ shown in FIG. 2;

FIG. 4 is a plan view illustrating an exemplary embodiment of a second optical pattern shown in FIG. 3 according to the present invention; and

FIG. 5 is a cross-sectional view illustrating an another exemplary embodiment of a display apparatus according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with Reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

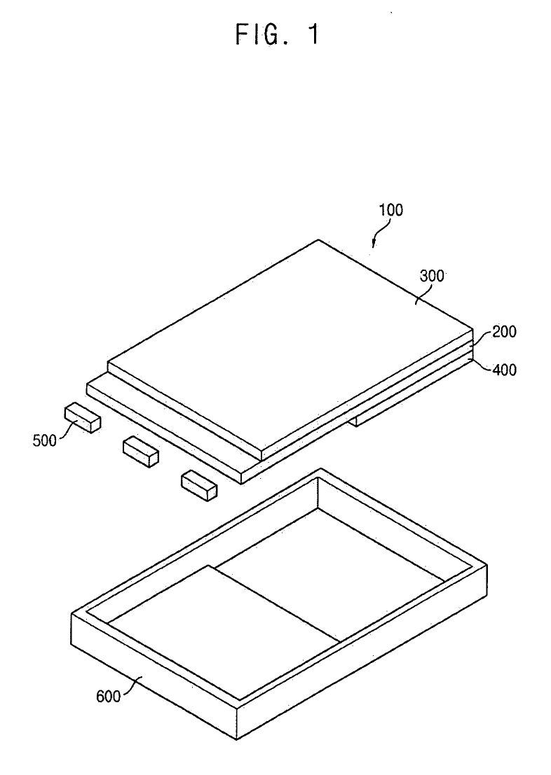

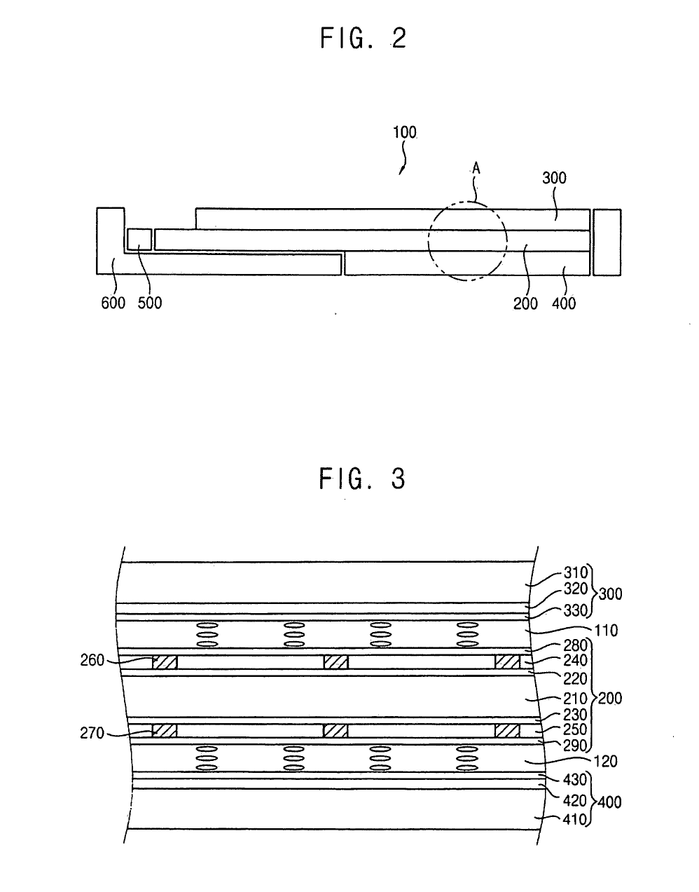

FIG. 1 is an exploded perspective view illustrating an exemplary embodiment of a display apparatus according to the present invention. FIG. 2 is a cross-sectional view illustrating the display apparatus shown in FIG. 1. FIG. 3 is an enlarged plan view illustrating a region ‘A’ shown in FIG. 2.

Referring to FIGS. 1 through 3, a display apparatus 100 includes a light-guide substrate 200, a first display substrate 300, a second display substrate 400 and a light source 500.

The light-guide substrate 200 is disposed between the first and second display substrates 300 and 400. The light-guide substrate 200 guides light generated by the light source 500 disposed next to a side of the light-guide substrate 200 to emit the light toward the first and second display substrates 300 and 400. The light-guide substrate 200 includes an incident surface, a first surface and a second surface. The incident surface is adjacent to the light source 500. The first surface is extended from the incident surface and faces the first display substrate 300. The second surface is opposite to the first surface.

According to an exemplary embodiment, as shown in FIG. 3, the light-guide substrate 200 includes a first transparent substrate 210, a first optical pattern 220 and a second optical pattern 230. The first optical pattern 220 is disposed on a first surface of the first transparent substrate 210, and disperses and reflects light. The second optical pattern 230 is disposed on a second surface of the first transparent substrate 210 opposite to the first surface, and disperses and reflects light.

According to an exemplary embodiment, the first transparent substrate 210 includes a transparent and thermostable material in order to guide light and which is capable of enduring a film forming process performed at a high temperature. According to an exemplary embodiment, the first transparent substrate 210 includes a glass material. However, the present invention is not limited hereto, and the material of the first transparent substrate 210 may vary, as necessary.

The first optical pattern 220 is formed on the first surface of the first transparent substrate 210 and disperses and reflects light incident into the first transparent substrate 210 toward the first display substrate 300. The second optical pattern 230 is formed on the second surface of the first transparent substrate 210 and disperses and reflects the light incident into the first transparent substrate 210 toward the first display substrate 300. The light incident into the first transparent substrate 210 is dispersed and reflected by the first and second optical patterns 220 and 230. The first and second surfaces of the first transparent substrate 210 reflect a portion of the light dispersed and reflected from the first and second surfaces, which includes a path inclined beyond a critical angle with respect to the first and second surface, so that the portion of the light is emitted toward the exterior.

According to an exemplary embodiment, the first and second optical patterns 220 and 230 include variable densities according to positions of the first and second surfaces so that the brightness of light emitted in two ways may be improved.

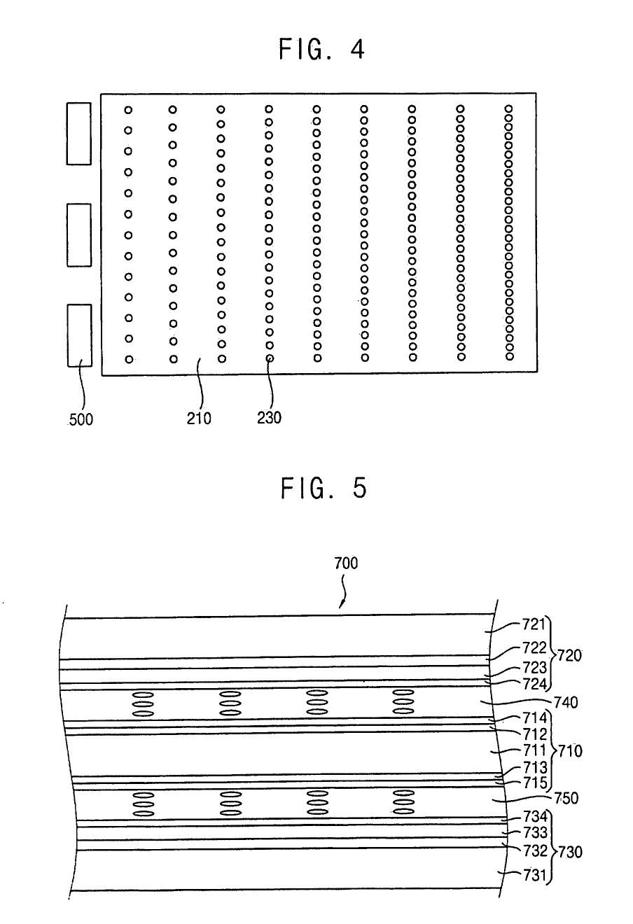

FIG. 4 is a plan view illustrating a second optical pattern shown in FIG. 3, according to an exemplary embodiment of the present invention.

Referring to FIG. 4, according to an exemplary embodiment of the present invention, a density of the second optical pattern 230 increases as a distance from the light source 500 increases. In the first surface of the first transparent substrate 210, an amount of light irradiated onto the first surface decreases as a distance from the light source 500 increases. Therefore, the brightness of light emitted from the first surface may be improved when the density of the second optical pattern 230 increases as the distance from the light source 500 increases. According to an exemplary embodiment, the density of the second optical pattern 230 may be controlled by a method of increasing the number of the second optical pattern 230 or a method of increasing the size of the second optical pattern 230.

According to an exemplary embodiment, the density of the first optical pattern 220 may also increase as the distance from the light source 500 increases. When the second display substrate 400 includes a smaller area than the first display substrate 300, the first optical pattern 220 may be formed only on the second surface corresponding to the second display substrate 400.

According to an exemplary embodiment, the first optical pattern 220 and the second optical pattern 230 may include printed patterns formed through a silk screen method. Alternatively, according to an exemplary embodiment, the first and second optical patterns 220 and 230 may include uneven patterns formed through a sand blasting method, a stamping method, or a molding method.

According to an exemplary embodiment, the light-guide substrate 200 further includes a first color filter layer 240 and a second color filter layer 250. The first color filter layer 240 is formed on the first surface of the first transparent substrate 210 facing the first display substrate 300. The second color filter layer 250 is formed on the second surface of the first transparent substrate 210 facing the second display substrate 400.

The first and second color filter layers 240 and 250 display colors. According to an exemplary embodiment, the first and second color filter layers 240 and 250 may include a photosensitive organic composition including pigments for displaying colors. According to an exemplary embodiment, each of the first and second color filter layers 240 and 250 may include a red color filter, a green color filter and a blue color filter. The red color filter includes a photosensitive organic composition having a red pigment. The green color filter includes a photosensitive organic composition having a green pigment. The blue color filter includes a photosensitive organic composition having a blue pigment. According to an exemplary embodiment, the red, green and blue color filters may form a predetermined pattern on the first and second surfaces of the first transparent substrate 210. According to an exemplary embodiment, the red, green and blue color filters of the first color filter layer 240 may be alternately formed along a first direction or a second direction substantially perpendicular to the first direction such that one color filter corresponds to each pixel of the first display substrate 300. The red, green and blue color filters of the second color filter layer 250 may be alternately formed along the first direction or the second direction such that one color filter corresponds to each pixel of the second display substrate 400.

According to an exemplary embodiment, the light-guide substrate 200 further includes a first black matrix 260 and a second black matrix 270. The first black matrix 260 is formed on the first surface facing the first display substrate 300. The second black matrix 270 is formed on the second surface facing the second display substrate 400.

According to an exemplary embodiment, the first black matrix 260 is formed among the red, green and blue color filters of the first color filter layer 240 and blocks light transmitted among the red,green and blue color filters. Therefore, the first black matrix 260 improves a contrast ratio of an image displayed on the first display substrate 300. The second black matrix 270 is formed among the red, green and blue color filters of the second color filter layer 250 and blocks light transmitted among the red, green and blue color filters of the second color filter layer 250. Therefore, the second black matrix 270 improves a contrast ratio of an image displayed on the second display substrate 400.

According to an exemplary embodiment, the light-guide substrate 200 further includes a first common electrode 280 and a second common electrode 290. The first common electrode 280 is formed in the first surface facing the first display substrate 300. The second common electrode 290 is formed on the second surface facing the second display substrate 400.

According to an exemplary embodiment, the first and second common electrodes 280 and 290 include a transparent conductive material for transmitting light. For example, the first and second common electrodes 280 and 290 include indium tin oxide (“ITO”) or indium zinc oxide (“IZO”). According to an exemplary embodiment, the first and second common electrodes 280 and 290 may include an opening pattern for improving a viewing angle.

The first display substrate 300 is disposed on the first surface of the light-guide substrate 200. The first display substrate 300 displays an image using light provided by the light-guide substrate 200.

According to an exemplary embodiment, the first display substrate 300 includes a second transparent substrate 310, a first thin-film transistor (“TFT”) layer 320 formed on the second transparent substrate 310 and a first pixel electrode 330 formed on the second transparent substrate 310.

According to an exemplary embodiment, the second transparent substrate 310 may include a transparent and thermostable material to transmit light. Thus, the second transparent substrate 310 may transmit light, and may be formed through a film forming process performed at a high temperature. According to an exemplary embodiment, the second transparent substrate 310 may include a glass material. However, the present invention is not limited hereto, and the material of the second transparent substrate 310 may vary, as necessary.

The first TFT layer 320 is formed on a surface of the second transparent substrate 310 facing the light-guide substrate 200. The first TFT layer 320 divides the first display substrate 300 into a plurality of pixels and independently drives the pixels so that the first display substrate 300 displays an image. The first TFT layer 320 may include a gate line, a data line, a TFT, and an overcoat layer. The gate line is formed through a thin-film forming process. The data line crosses the gate line and is insulated from the gate line by a gate insulating layer. The TFT is connected to the gate and data lines and each pixel includes at least one TFT. The overcoat layer covers the data line and the TFT.

The first pixel electrode 330 is opposite to the first common electrode 280. The first pixel electrode 330 is formed on the first TFT layer 320. The first pixel electrode 330 is patterned to correspond to each pixel and connected to the TFT formed in each pixel.

The first pixel electrode 330 includes a transparent conductive material to transmit light. For example, the first pixel electrode 330 may include IZO or ITO. The first pixel electrode 330 may include an opening pattern for improving a viewing angle.

The second display substrate 400 is disposed on the second surface of the light-guide substrate 200. The second display substrate 400 displays an image using light provided by the light-guide substrate 200.

According to an exemplary embodiment, the second display substrate 400 includes a third transparent substrate 410, a second TFT layer 420 formed on the third transparent substrate 410 and a second pixel electrode 430 formed on the third transparent substrate 410.

According to an exemplary embodiment, the third transparent substrate 410 may includes a transparent and thermostable material so that the third transparent substrate 410 may transmit light and be formed through the film forming process performed at a high temperature. According to an exemplary embodiment, the third transparent substrate 410 may include a glass material. However, the present invention is not limited hereto, and the material of the third transparent substrate 410 may vary, as necessary.

The second TFT layer 420 is formed on a surface of the third transparent substrate 410 facing the light-guide substrate 200. The second TFT layer 420 divides the second display substrate 400 into a plurality of pixels and independently drives the pixels so that the second display substrate 400 displays an image. The second TFT layer 420 may include a gate line, a data line, a TFT, and an overcoat layer. The gate line is formed through a thin-film forming process. The data line crosses the gate line and is insulated from the gate line by a gate insulating layer. The TFT is connected to the gate and data lines and each pixel includes at least one TFT. The overcoat layer covers the data line and the TFT.

The second pixel electrode 430 is opposite to the second common electrode 290. The second pixel electrode 430 is formed on the second TFT layer 420. The second pixel electrode 430 is patterned to correspond to each pixel of the second display substrate 400 and connected to the TFT.

The second pixel electrode 430 includes a transparent conductive material to transmit light. According to an exemplary embodiment, the second pixel electrode 430 may include IZO or ITO. The second pixel electrode 430 may include an opening pattern for improving a viewing angle.

According to an exemplary embodiment, the first display substrate 300 may have substantially a same size as the second display substrate 400. Alternatively, according to an exemplary embodiment, the first display substrate 300 may have a different size from the second display substrate 400. For example, when the first display substrate 300 displays a main image concerning communication information, pictures, movies, etc., and the second display substrate 400 displays a supplementary image concerning the date, time, etc., the second display substrate 400 may include a smaller size than the first display substrate 300.

The light source 500 is disposed next to at least one side of the light-guide substrate 200, and provides the first transparent substrate 210 with light. According to an exemplary embodiment, the light source may include at least one light-emitting diode (“LED”). Alternatively, according to an exemplary embodiment, the light source 500 may include a cold cathode fluorescent lamp (“CCFL”).

According to an exemplary embodiment, the display apparatus 100 further includes a first liquid crystal layer 110 and a second liquid crystal layer 120. The first liquid crystal layer 110 is disposed between the first display substrate 300 and the light-guide substrate 200. The second liquid crystal layer 120 is disposed between the second display substrate 400 and the light-guide substrate 200.

The first liquid crystal layer 110 includes liquid crystal molecules of which an arrangement is changed by an electric field formed by the first pixel electrode 330 and the first common electrode 280 which controls an amount of light passing through the first liquid crystal layer 110. The second liquid crystal layer 120 includes liquid crystal molecules of which arrangement is changed by an electric field formed by the second pixel electrode 430 and the second common electrode 290 which controls an amount of light passing through the second liquid crystal layer 120.

According to an exemplary embodiment, the display apparatus 100 further includes a receiving container 600 which receives the light-guide substrate 200, the first display substrate 300, the second display substrate 400, and the light source 500. According to an exemplary embodiment, the receiving container 600 may include a plastic material. An upper portion and a lower portion of the receiving container 600 may be partially opened so that the first and second display substrates 300 and 400 may be exposed. Therefore, the display apparatus 100 displays images on the first display substrate 300 and the second display substrate 400.

FIG. 5 is a cross-sectional view illustrating another exemplary embodiment of a display apparatus according to the present invention.

Referring to FIG. 5, a display apparatus 700 according to another exemplary embodiment of the present invention includes a light-guide substrate 710, a first display substrate 720 and a second display substrate 730.

According to an exemplary embodiment, the light-guide substrate 710 includes a first transparent substrate 711, a first optical pattern 712 and a second optical pattern 713. The first transparent substrate 711 includes an incident surface, a first surface and a second surface. The incident surface is adjacent to a light source 500 (shown in FIG. 2). The first surface is extended from thee incident surface and faces the first display substrate 720. The second surface is opposite to the first surface. The first optical pattern 711 is formed on the third surface of the first transparent substrate 711. The second optical pattern 713 is formed on the second surface of the first transparent substrate 711 opposite to the third surface. According to an exemplary embodiment, the light-guide substrate 710 further includes a first common electrode 714 and a second common electrode 715. The first common electrode 714 is formed on the first surface of the first transparent substrate 711. The second common electrode 715 is formed on the second surface of the first transparent substrate 711. According to an exemplary embodiment, the light-guide substrate 710 further includes a first black matrix (not shown) and a second black matrix (not shown). The first black matrix may be formed on the first surface facing the first display substrate 720. The second black matrix may be formed on the second surface facing the second display substrate 730.

According to an exemplary embodiment, the first display substrate 720 is disposed on the first surface. A first liquid crystal layer 740 is disposed between the first display substrate 720 and the light-guide substrate 710. The first display substrate 720 displays an image using light provided by the light-guide substrate 710. The first display substrate 720 includes a second transparent substrate 721, a first TFT layer 722 and a first color filter layer 723 which displays color. The first TFT layer 722 and the first color filter layer 723 are formed on the second transparent substrate 721. According to an exemplary embodiment, the first display substrate 720 further includes a first pixel electrode 724 formed on the first color filter layer 723.

The second display substrate 730 is disposed in the second surface. A second liquid crystal layer 750 is disposed between the second display substrate 730 and the light-guide substrate 710. The second display substrate 730 displays an image using light provided by the light-guide substrate 710. The second display substrate 730 may include a third transparent substrate 731, a second TFT layer 732 and a second color filter layer 733 which displays color. According to an exemplary embodiment, the second TFT layer 732 and the second color filter layer 733 may be formed on the third transparent substrate 731. The second display substrate 730 may further include a second pixel electrode 734 formed on the second color filter layer 733.

According to an exemplary embodiment, the present invention provides a display apparatus having one color filter substrate disposed between two display substrates to display images in two directions and a light source is disposed next to a side of the color filter substrate. The display apparatus does not require a light-guide plate so that a thickness of the display apparatus may be reduced and manufacturing costs may be reduced.

While the present invention has been shown and described with reference to some exemplary embodiments thereof, it should be understood by those of ordinary skill in the art that various changes in form and details may be made therein without departing from the spirit and scope of the present invention as defined by appended claims.

What is claimed is:

1. A display apparatus comprising:
at least one display substrate which displays an image;
a light source which generates light; and
a light-guide substrate which guides light generated by the light source to emit the light toward the at least one display substrate and comprises:
an incident surface adjacent to the light source,
a first surface extended from the incident surface, the first surface including a first color filter layer which is formed thereon and displays color, and
a second surface opposite to the first surface.

2. The display apparatus of claim 1, wherein the light-guide substrate further comprises:
a first optical pattern which is formed on the first surface and disperses and reflects light; and
a second optical pattern which is formed on the second surface and disperses and reflects light.

3. The display apparatus of claim 2, wherein a density of each of the first and second optical patterns increases as a distance from the light source increases.

4. The display apparatus of claim 1, wherein the light-guide substrate further comprises a second color filter layer which is formed on the second surface and displays color.

5. The display apparatus of claim 4, wherein the light-guide substrate further comprises:
a first common electrode which is formed on the first surface and transmits light; and
a second common electrode which is formed on the second surface and transmits light.

6. The display apparatus of claim 4, wherein the light-guide substrate further comprises:
a first black matrix which is formed on the first surface and blocks light transmitted among filters of the first color filter layer; and
a second black matrix which is formed on the second surface and blocks light transmitted among filters of the second color filter layer.

7. The display apparatus of claim 4, wherein the at least one display substrate comprises:
a first display substrate disposed on the first surface of the light-guide substrate; and
a second display substrate disposed on the second surface of the light-guide substrate.

8. The display apparatus of claim 7, wherein the first display substrate comprises:
a first thin-film transistor layer including at least one thin-film transistor formed in each pixel; and
a first pixel electrode formed on the first thin-film transistor layer.

9. The display apparatus of claim 8, wherein the second display substrate comprises:
a second thin-film transistor layer including at least one thin-film transistor formed in each pixel; and
a second pixel electrode formed on the second thin-film transistor layer.

10. The display apparatus of claim 7, further comprising:
a first liquid crystal layer which is formed between the first display substrate and the light-guide substrate; and
a second liquid crystal layer which is formed between the second display substrate and the light-guide substrate.

11. The display apparatus of claim 7, wherein each of the light-guide substrate, the first display substrate and the second display substrate comprises a glass material.

12. The display apparatus of claim 7, further comprising a receiving container which receives the light-guide substrate, the first display substrate, the second display substrate, and the light source.

13. The display apparatus of claim 1, wherein the light source comprises at least one light-emitting diode.

14. A display apparatus comprising:
a light source Which generates light;
a light-guide substrate which guides light generated by the light source and comprises an incident surface adjacent to the light source, a first surface extended from the incident surface and a second surface opposite to the first surface;
a first display substrate Which is disposed on the first surface of the light-guide substrate and displays an image, the first display substrate comprising a first thin-film transistor layer and a first color filter layer which is formed thereon and displays color; and
a second display substrate which is disposed on the second surface of the light-guide substrate and displays an image, the second display substrate comprising a second thin-film transistor layer and a second color filter layer which is formed thereon and displays color.

15. The display apparatus of claim 14, wherein the light-guide substrate comprises:
a first optical pattern which is formed on the first surface and disperses and reflects light; and
a second optical pattern which is formed on the second surface and disperses and reflects light.

16. The display apparatus of claim 15, further comprising:
a first liquid crystal layer which is disposed between the first display substrate and the light-guide substrate; and
a second liquid crystal layer which is disposed between the second display substrate and the light-guide substrate.

17. The display apparatus of claim 16, wherein the light-guide substrate further comprises a first common electrode which is formed on the first surface and transmits light, and a second common electrode which is formed on the second surface and transmits light,
the first display substrate further comprises a first pixel electrode formed on the first thin-film transistor layer, and
the second display substrate further comprises a second pixel electrode formed on the second thin-film transistor layer.

18. A display apparatus comprising:
a light-guide substrate comprising a first surface and a second surface opposite to the first surface, a first optical pattern which disperses and reflects light, and a first color filter layer which is formed on the first surface and displays color, and a second optical pattern which disperses and reflects light and a second color filter layer which is formed on the second surface and displays color;
a first display substrate which is disposed on the first surface and displays an image, the first display substrate comprising a first thin-film transistor layer having at least one thin-film transistor formed in each pixel;
a second display substrate Which is disposed on the second surface and displays an image, the second display substrate comprising a second thin-film transistor layer having at least one, thin-film transistor formed in each pixel; and
a light source which is disposed adjacent to a side of the light-guide substrate and generates light.

19. The display apparatus of claim 18, further comprising:
a first liquid crystal layer which is disposed between the first display substrate and the light-guide substrate; and
a second liquid crystal layer which is disposed between the second display substrate and the light-guide substrate.

20. The display apparatus of claim 19, wherein the light-guide substrate further comprises a first common electrode which is formed on the first surface and transmits light, and a second common electrode which is formed on the second surface and transmits light,
the first display substrate further comprises a first pixel electrode formed on the first thin-film transistor layer, and
the second display substrate further comprises a second pixel electrode formed on the second thin-film transistor layer.
